(19) United States
(12) Patent Application Publication
(10) Pub. No.: US 2011/0123890 A1
(43) Pub. Date: May 26, 2011

(54) FUEL CELL STACK AND FLAT-PLATE SOLID OXIDE FUEL CELL USING SAME

(76) Inventor: Takashi Miyazawa, Ibaraki (JP)

(21) Appl. No.: 12/934,707

(22) PCT Filed: Mar. 27, 2009
(86) PCT No.: PCT/JP2009/001390

§ 371 Date: Dec. 20, 2010

(30) Foreign Application Priority Data
Mar. 28, 2008 (JP) 2008-087832

(51) Int. Cl. H01M 8/24

(52) U.S. Cl. 429/456

(57) ABSTRACT

An object of the present invention is to provide a fuel cell stack which can prevent both cell voltages from decreasing and cracks from occurring in a solid electrolyte under the action of mechanical stress and a flat plate solid oxide fuel cell using the same. In order to achieve this object, the present invention provides a fuel cell stack having a sealless structure in which a plurality of power generation cells (16), each of which has a fuel electrode layer (12) formed on one (lower) surface of a plate-like solid electrolyte (11) and an oxidant electrode layer (13) formed on the other (upper) surface thereof, are laminated in a plate thickness direction by interposing a separator (2) between the power generation cells (16); and in which a fuel electrode current collector (14) is interposed between the fuel electrode layer and the separator and an oxidant electrode current collector (15) is interposed between the oxidant electrode layer and the separator, wherein an annular member (17) with a thickness thinner than a fuel electrode current collector interposed between the separator and the solid electrolyte or a raised portion with a height not to be in contact with a solid electrolyte formed on a fuel electrode current collector side of the separator is provided on an outer periphery of the fuel electrode current collector.

### TECHNICAL FIELD

The present invention relates to a flat plate fuel cell stack in which a plurality of power generation cells, each of which has a fuel electrode layer formed on one surface of a plate-like solid electrolyte and an oxidant electrode layer formed on the other surface thereof, are laminated in a plate thickness direction by interposing a separator between the power generation cells and a flat plate solid oxide fuel cell using the same.

### Background Art

In recent years, a fuel cell which directly converts the chemical energy of fuel to electrical energy has gained attention as a highly efficient and clean power generating apparatus. Currently, more attention has been paid to the development of not only a polymer electrolyte fuel cell (PEFC) available on the market but also a first generation phosphoric acid fuel cell (PAFC), a second generation molten-carbonate fuel cell (MCFC), and a third generation solid oxide fuel cell (SOFC). Above all, the solid oxide fuel cell (SOFC) has an operating temperature as high as 600° C. to 1000° C., can provide an efficient use of exhaust heat, is suitable for an application of a large scale power generation, and thus can be used for a wide range of applications from home use of 1 kw to 10 kw and commercial use to an alternate thermal power plant.

As the solid oxide fuel cell, generally, there has been known a flat plate solid oxide fuel cell having a flat plate fuel cell stack of a sealless structure in which a plurality of power generation cells, each of which has an oxidant electrode layer (cathode) formed on one surface of a plate-like solid electrolyte and a fuel electrode layer (anode) formed on the other surface thereof, are laminated in a plate thickness direction by interposing a separator between the power generation cells. Moreover, a fuel electrode current collector is interposed between the fuel electrode layer and the separator and an oxidant electrode current collector is interposed between the oxidant electrode layer and the separator.

In the flat plate solid oxide fuel cell, at power generation, an oxidant gas (oxygen) is supplied as a reactant gas to an oxidant electrode layer side and a reformed gas (H₂, CO, CO₂, H₂O, etc.) obtained by reforming a fuel gas (town gas containing CH₄ etc.) by a reformer is supplied to a fuel electrode layer side. The oxidant electrode layer and the fuel electrode layer each are configured as a porous layer so as to allow the reactant gas to reach the interface with the solid electrolyte layer.

Thus, in the power generation cell, the oxygen supplied to the oxidant electrode layer side reaches near the interface with the solid electrolyte layer through pores in the oxidant electrode layer, and receives electrons at that portion from the oxidant electrode layer to be ionized into oxide ions (O²⁻). Then, the oxide ions diffusively move through the solid electrolyte layer toward the fuel electrode layer. The oxide ions which reach near the interface with the fuel electrode layer react with a reformed gas at that portion to produce a reacted gas product (H₂O, CO₂, and the like) and emit electrons to the fuel electrode layer.

Thus, the electrons generated by electrode reaction can be extracted as an electromotive force by an external load through a different route. At the same time, the above described reacted gas together with an unreacted gas such as a reformed gas gradually diffuses in the course of the electrode reaction from the fuel electrode layer side to the outside of the flat plate fuel cell stack having a sealless structure. On the other hand, the oxidant gas and the like gradually diffuse from the oxidant electrode layer side to the outside of the flat plate fuel cell stack.

However, the above flat plate fuel cell stack having a sealless structure has a possibility that the oxygen inside the oxidant gas diffused from the oxidant electrode layer side to the outside thereof and external air flow back toward around the fuel electrode layer, thereby causing the fuel electrode layer to be oxidized and each power generation cell voltage to decrease.

In light of this, the present inventors have previously proposed a flat plate solid oxide fuel cell providing an insulating cover having a gas discharge hole so as to cover the outer periphery of the fuel electrode layer and the fuel electrode current collector as disclosed in Patent Document 1.

The flat plate solid oxide fuel cell can increase the linear velocity of a reacted gas diffused outside from the fuel electrode layer side through the gas discharge hole of the insulating cover and an unreacted gas such as a reformed gas. Thus, the flat plate solid oxide fuel cell can prevent the fuel electrode layer from being oxidized by the oxygen inside the oxidant gas released from the oxidant electrode layer side at power generation and external air flowing back toward around the fuel electrode layer, and thereby can prevent each power cell voltage from decreasing.

However, the solid electrolyte in the flat plate solid oxide fuel cell has a problem in that when thermal strain such as thermal expansion occurs in the solid electrolyte at power generation, mechanical stress also acts thereon because the insulating cover is in contact therewith, and thus the solid electrolyte is easily broken.

Patent Document 1: Japanese Patent Laid-Open No. 2005-85521

### DISCLOSURE OF THE INVENTION

In view of the above, an object of the present invention is to provide a fuel cell stack which can prevent both cell voltages from decreasing and cracks from occurring in the solid electrolyte under the action of mechanical stress as described above and a flat plate solid oxide fuel cell using the same.

More specifically, a fuel cell stack according to a first aspect of the present invention provides a provides a fuel cell stack having a sealless structure in which a plurality of power generation cells, each of which has a fuel electrode layer formed on one surface of a flat plate-like solid electrolyte and an oxidant electrode layer formed on the other surface thereof, are laminated in a plate thickness direction by interposing a separator which includes a fuel gas path supplying a fuel gas to the fuel electrode layer and an oxidant gas path supplying an oxidant gas to the oxidant electrode layer; in which a fuel electrode current collector is interposed between the fuel electrode layer and the separator and an oxidant electrode current collector is interposed between the oxidant electrode layer and the separator; and in which a reacted gas generated by a reaction between the fuel gas and the oxidant gas and an unreacted gas not used for the reaction are released as an exhaust gas from the outer periphery to outside, wherein a raised portion with a height not to be in contact with the solid electrolyte formed on the fuel electrode current collector side of the separator is provided on an outer periphery of the fuel electrode current collector.

A fuel cell stack according to a second aspect of the present invention provides a fuel cell stack having a sealless structure in which a plurality of power generation cells, each of which has a fuel electrode layer formed on a lower surface of a flat plate-like solid electrolyte and an oxidant electrode layer formed on an upper surface thereof, are laminated in a plate thickness direction by interposing a separator which includes a fuel gas path supplying a fuel gas to the fuel electrode layer and an oxidant gas path supplying an oxidant gas to the oxidant electrode layer; in which a fuel electrode current collector is interposed between the fuel electrode layer and the separator and an oxidant electrode current collector is interposed between the oxidant electrode layer and the separator; and in which a reacted gas generated by a reaction between the fuel gas and the oxidant gas and an unreacted gas not used for the reaction are released as an exhaust gas from the outer periphery to outside, wherein an annular member with a thickness thinner than that of the fuel electrode current collector interposed between the separator and the solid electrolyte is provided on an outer periphery of the fuel electrode current collector.

Here, the annular member is, for example, a flat plate annular member with a uniform plate thickness over the entire periphery.

The solid oxide fuel cell according to the present invention provides a flat plate solid oxide fuel cell having a plurality of fuel cell stacks according to the second aspect of the present invention, wherein the solid electrolyte is formed into a circular plate shape; the fuel electrode layer is formed into a circular shape; the fuel electrode current collector is formed into a circular plate shape; and the flat plate annular member is an annular shaped ring member having an insulating property.

According to the fuel cell stack according to the first or second aspect of the present invention and the flat plate solid oxide fuel cell according to the present invention, the annular member interposed between the separator and the solid electrolyte or the raised portion formed on the separator is provided on the outer periphery of the fuel electrode current collector. Therefore, the flat plate solid oxide fuel cell can increase the linear velocity of an exhaust gas of an unreacted gas such as a reacted gas and a reformed gas diffused outside from the fuel electrode layer through an opening between an upper portion of the annular member and the solid electrolyte or an opening between an upper portion of the raised portion and the solid electrolyte. Thus, the flat plate solid oxide fuel cell can prevent the fuel electrode layer from being oxidized by the oxygen inside the oxidant gas released from the oxidant electrode layer side at power generation and external air flowing back toward around the fuel electrode layer, and thereby can prevent each power generation cell voltage from decreasing.

Further, the thickness of the annular member is thinner than that of the fuel electrode current collector and the height of the raised portion is not so high as to contact the solid electrolyte. Therefore, even if thermal strain such as thermal expansion occurs in the solid electrolyte at power generation, mechanical stress does not act thereon because the annular member and the raised portion do not contact the solid electrolyte, thereby preventing the solid electrolyte from being cracked.

Thus, the present invention can prevent both cell voltages from decreasing and cracks from occurring in the solid electrolyte under the action of mechanical stress.

In particular, the fuel cell stack according to the second aspect of the present invention provides a flat plate annular member having a uniform plate thickness over the entire periphery between the separator and the solid electrolyte and thus allows the opening for releasing the exhaust gas to be uniformly narrow over the peripheral direction. Therefore, the fuel cell stack can equalize the linear velocity of the exhaust gas diffused outside from the fuel electrode layer through the opening and can prevent the fuel electrode layer from being oxidized by the oxygen or air locally flowing back toward around the fuel electrode layer, thereby preventing power generation cell voltages from decreasing.

In addition, according to the flat plate solid oxide fuel cell of the present invention, the solid electrolyte, the fuel electrode layer, and the fuel electrode current collector each are formed into a circular shape and the flat plate annular member is formed as an annular shaped ring member. Therefore, unlike a polygonal shape having a corner such as a rectangular shape, the fuel electrode layer, the current collector, and the solid electrolyte can be prevented from being damaged by a contact caused by vibration. In particular, even if the ring member contacts the fuel electrode current collector, the action of mechanical stress on the fuel electrode current collector can be minimized as much as possible. Thus, the present invention can suppress the decrease in power generation due to damage and cracks caused by the damage.

Further, the flat plate annular member is thinner than the total thickness of the fuel electrode layer and the fuel electrode current collector, and thus the flatness deteriorates, but because of its insulating property, even a partial contact with the solid electrolyte may not cause electrical short.

### BRIEF DESCRIPTION OF THE DRAWINGS

FIG. 1 is a perspective view for describing a configuration of a fuel cell stack 10 according to the present invention;

FIG. 2 is a side view of a power generation cell 16 of FIG. 1;

FIG. 3A is a plan view illustrating the configuration of the fuel cell stack 10;

FIG. 3B is a side view illustrating the configuration of the fuel cell stack 10;

FIG. 4 is a longitudinal sectional view of the flat plate solid oxide fuel cell according to the present invention; and

FIG. 5 is a cross-sectional view of the same solid oxide fuel cell.

### DESCRIPTION OF SYMBOLS

2 Separator
10 Fuel cell stack
11 Solid electrolyte
12 Fuel electrode layer
13 Oxidant electrode layer
14 Fuel electrode current collector
15 Oxidant electrode current collector
16 Power generation cell
17 Ring member
20 Separator body
21 Separator arm
23 Fuel gas path
24 Oxidant gas path

### BEST MODE FOR CARRYING OUT THE INVENTION

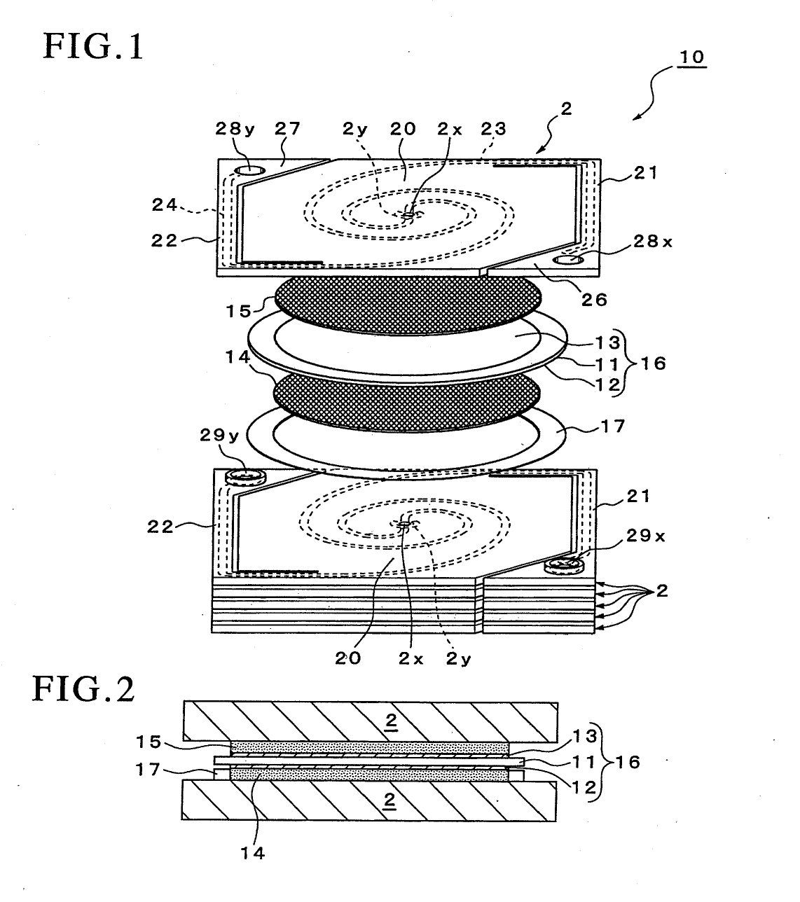

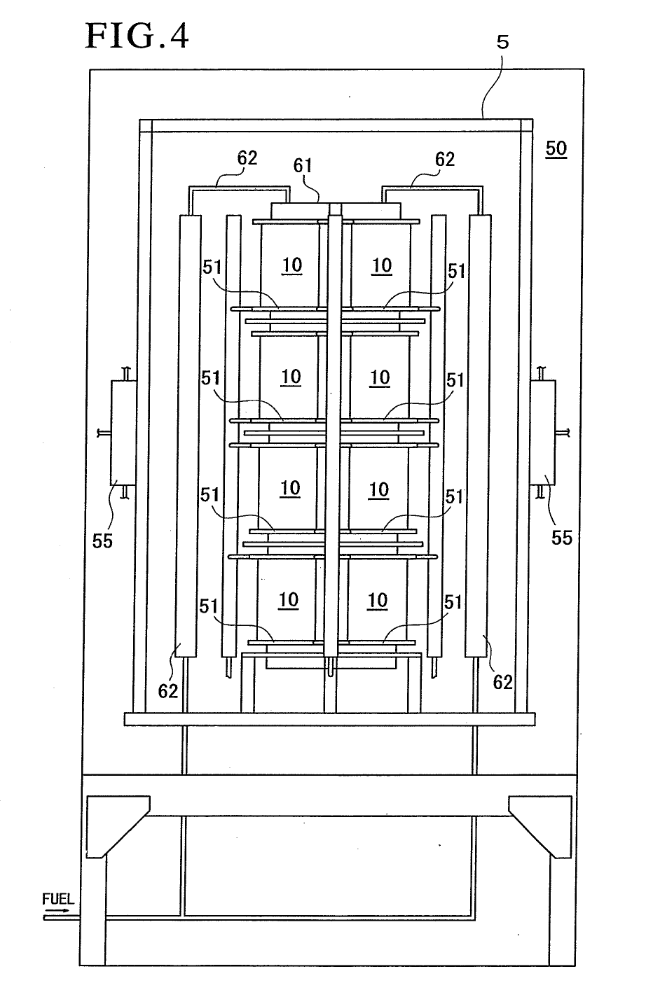

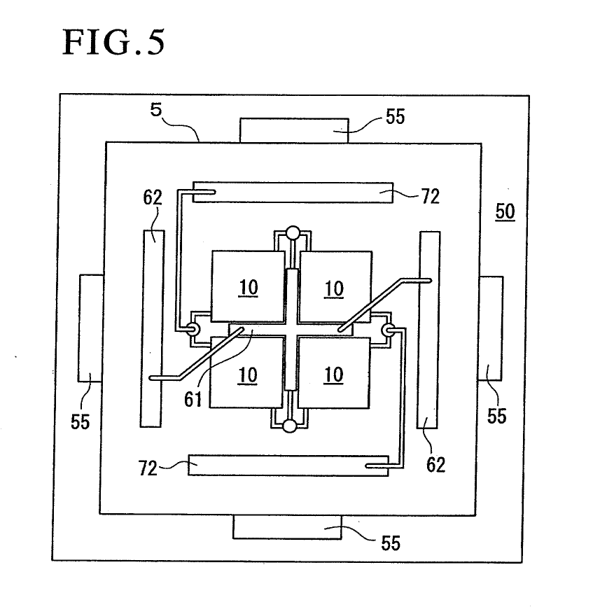

Hereinafter, embodiments of a flat plate solid oxide fuel cell according to the present invention will be described by referring to FIGS. 1 to 5.

As illustrated in FIGS. 1 and 2, a fuel cell according to the present embodiment is configured to have a fuel cell stack 10 which has an external appearance of a substantially rectangular columnar shape and in which a plurality of power generation cells 16, each of which has a fuel electrode layer 12 formed on a lower surface of a solid electrolyte 11 and an oxidant electrode layer 13 formed on an upper surface thereof, are laminated in a plate thickness direction by interposing a rectangular plate-like separator 2 between the power generation cells.

Further, a circular plate-like fuel electrode current collector 14 is interposed between the fuel electrode layer 12 of each power generation cell 16 and the separator 2; and a circular plate-like oxidant electrode current collector 15 is interposed between the oxidant electrode layer 13 and the separator 2.

This solid electrolyte 11 is made of circular plate-like lanthanum gallate ceramic plate expressed by the composition formula La₁₋ₓSrₓGa_{1-y}Mg_{y}O₃ (X=0.05 to 0.3, Y=0.025 to 0.3), or La₁₋ₓSrₓGa_{1-y-z}Mg_{y}Co_{z}O₃ (X=0.05 to 0.3, Y=0 to 0.29, Z=0.01 to 0.3, Y+Z=0.025 to 0.3).

The fuel electrode layer 12 is made of a metal such as Ni or a cermet such as Ni—YSZ, Ni—SDC, and Ni-GDC. The oxidant electrode layer 13 is made of LaMnO₃, LaCoO₃, SrCoO₃ or the like. The fuel electrode current collector 14 is made of a sponge-like porous sintered metal plate such as Ni and formed into a circular plate shape with the same diameter as that of the fuel electrode layer 12. The oxidant electrode current collector 15 is made of a sponge-like porous sintered metal plate such as Ag and formed into a circular plate shape with the same diameter as that of the air electrode layer 13.

Further, a ring member 17 interposed between the solid electrolyte 11 and the separator 2 is provided on an outer periphery of the fuel electrode current collector 14 and the fuel electrode layer 12. The ring member 17 has a plate thickness thinner than that of the fuel electrode current collector 14 and is formed into a flat plate annular shape having a uniform plate thickness over the entire periphery.

Furthermore, the ring member 17 is made of an insulating material such as alumina and zirconia. The internal diameter of the ring member 17 is formed to be substantially the same as or slightly larger than the external diameter of the fuel electrode current collector 14, preferably, substantially the same as the external diameter of the fuel electrode current collector 14, and the fuel electrode current collector 14 and the like are fitted therein.

This is because the configuration in which the fuel electrode current collector 14 is fitted inside the ring member 17 can prevent cracks or chips from occurring in the ring member 17 or the power generation cell 16 due to a contact caused by vibration between the fuel electrode current collector 14 and the ring member 17.

Briefly, the fuel cell stack 10 is configured by repeatedly laminating the separator 2, the ring member 17, and the like in such a manner that the ring member 17 is placed as is on a surface of the separator 2; the fuel electrode current collector 14 is arranged inside the ring member 17; the power generation cell 16 is arranged with the fuel electrode layer 12 oriented toward inside the ring member 17; and then the oxidant electrode current collector 15 is placed on the oxidant electrode layer 13 of the power generation cell 16.

The separator 2 constituting the fuel cell stack 10 by sandwiching the power generation cell 16 and the like is made of a substantially square stainless plate with a thickness of several mm and is configured to include: a central separator body 20 laminating the above described power generation cell 16, each of the current collectors 14 and 15, and the ring member 17; and a pair of separator arms 21 and 22, each of which extends in a plane direction from the separator body 20 and supports a mutually facing edge portion of the separator body 20 at two positions.

The separator body 20 has a function of electrically connecting between the power generation cells 16 through the current collectors 14 and 15 as well as a function of supplying reactant gas to each power generation cell 16. The separator body 20 includes a fuel gas path 23 which introduces fuel gas from an edge portion of the separator 2 to the inside thereof and ejects the fuel gas from a discharge outlet 2x in a center portion of a surface facing the fuel electrode current collector 14 of the separator 2; and an oxidant gas path 24 which introduces an oxidant gas (air) from an edge portion of the separator 2 and ejects the oxidant gas from a discharge outlet 2y in a center portion of a surface facing the oxidant electrode current collector 15 of the separator 2.

Each of the separator arms 21 and 22 has a structure having flexibility in the lamination direction as a long strip shape extending along an outer periphery of the separator body 20 toward a mutually facing corner portion having a slight space therebetween and a pair of gas holes 28x and 28y penetrating through in the plate thickness direction are provided on end portions 26 and 27 of the separator arms 21 and 22.

One gas hole 28x is communicatively connected to the fuel gas path 23 of the separator 2 and the other gas hole 28y is communicatively connected to the oxidant gas path 24 of the separator 2, so as to supply fuel gas and oxidant gas to each surface of the respective electrodes 12 and 13 of each power generation cell 16 through the respective gas paths 23 and 24 from the respective gas holes 28x and 28y.

Then, the power generation cell 16 and current collectors 14 and 15 are interposed between the main bodies 20 of each separator 2 and insulating manifold rings 29x and 29y are interposed between the respective gas holes 28x and 28y of each separator 2, thereby providing a fuel cell stack 10 having an external appearance of a substantially rectangular columnar shape which has a fuel gas manifold including the gas hole 28x and the manifold ring 29x; and an air manifold including the gas hole 28y and the manifold ring 29y.

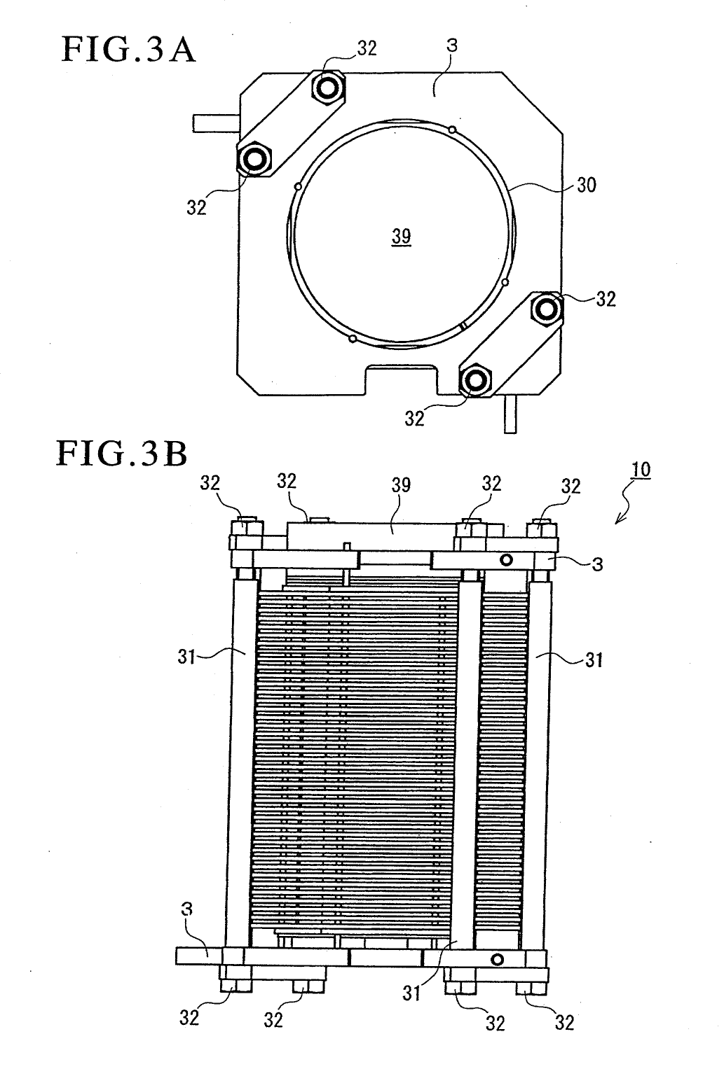

As illustrated in FIGS. 3A and 3B, a flange 3 with an external dimension greater than that of the separator 2 is provided on an upper portion and a lower portion of the fuel cell stack 10. Two bolts 31 each are inserted into two positions corresponding to the manifolds of the flange 3 and the nuts 32 are threadedly fitted in both end portions thereof. The flange 3 and the bolts 31 each threadedly fitting the nut 32 in both end portions maintain gas sealing of the manifold interposing the above described manifold rings 29x and 29y.

A hole 30 with an external dimension greater than that of the power generation cell 16 is provided in a center portion of the upper flange 3. A weight 39 with substantially the same size as that of the power generation cell 16 placed on the uppermost separator 2 is disposed on the hole 30. The weight 39 maintains mutual adhesion between the separator 2 and the power generation cell 16 sandwiched between the current collectors 14 and 15.

The fuel cell stack 10 configured in this manner is provided in a center portion of an internal can body 5 having a rectangular tube enclosed by four side plates, a top plate, and a bottom plate, and is placed on a rack 51 in such a manner that a large number of fuel cell stacks are arranged in a plane direction so as to form a plurality of rows (two rows in the present embodiment) and a plurality of columns (two columns in the present embodiment) and a plurality of (four in the present embodiment) fuel cell stacks are provided in an up/down height direction. Note that each fuel cell stack 10 is connected to a fuel gas supply line supplying a reformed fuel gas to a fuel gas manifold and an oxidant gas supply line supplying an oxidant gas such as oxygen to an air manifold and has a sealless structure in which at power generation, a reacted gas generated by a reaction between an oxidant gas and a reformed gas and an unreacted gas are released outside as is and the inside of the internal can body 5 can be maintained at a temperature required for power generation by combustion heat of thus released unreacted gas.

Further, the outer periphery of the internal can body 5 is covered with a heat insulating material 50, and inside or near the internal can body 5, a steam generator (not illustrated), a fuel heat exchanger 62, and a reformer 61 are interposedly provided on the above described fuel gas supply line and an air heat exchanger 72 is interposedly provided on the oxidant gas supply line. An infrared burner 55 for increasing the internal temperature at start-up is provided on each side plate of the internal can body 5. Thus, the fuel cell is configured such that the reformed gas supplied to the fuel gas manifold is supplied to the fuel electrode layer 12 of the power generation cell 16 of each stack 10, and the oxidant gas supplied to the air manifold is supplied to the oxidant electrode layer 13 of the power generation cell 16 of each stack 10.

According to the flat plate solid oxide fuel cell of the present embodiment, the ring member 17 having a thickness thinner than that of the fuel electrode current collector 14 interposed between the solid electrolyte 11 and the separator 2 and having a uniform plate thickness over the entire periphery is provided on an outer periphery of the fuel electrode current collector 14 and the fuel electrode layer 12, and thus an opening formed between an upper portion of the ring member 17 and the solid electrolyte 11 can be uniformly narrow over the peripheral direction. Therefore, the present embodiment can uniformly increase the linear velocity of an exhaust gas of an unreacted gas such as a reacted gas and a reformed gas diffused outside through the opening, and can prevent the oxygen in the oxidant gas released from the oxidant electrode layer 13 side at power generation and external air in the internal can body 5 from flowing back toward around the fuel electrode layer 12 over the entire periphery of the opening. Thus, the present embodiment can prevent the fuel electrode layer 12 from being oxidized by the flow back of the oxygen and external air and thus can prevent the voltage of each power generation cell 16 from decreasing.

In addition, the plate thickness of the ring member 17 is formed to be thinner than that of the fuel electrode current collector 14. Therefore, even if thermal strain such as thermal expansion occurs in the solid electrolyte 11 at power generation, mechanical stress does not act thereon because the ring member 17 does not contact the solid electrolyte 11, thereby preventing the solid electrolyte 11 from being cracked.

Thus, the present embodiment can prevent both cell voltages from decreasing and cracks from occurring in the solid electrolyte 11 under the action of mechanical stress.

Further, the solid electrolyte 11, the fuel electrode layer 12, and the fuel electrode current collector 14 each are formed into a circular shape and the ring member 17 is formed as an annular shaped ring member. Therefore, unlike a polygonal shape having a corner such as a rectangular shape, damage to the fuel electrode layer 12 and the solid electrolyte 11 due to contact caused by vibration can be suppressed. Thus, the present invention can suppress the decrease in an amount of power generation due to a damage and cracks caused by the damage.

Further, the fuel electrode current collector 14 and the oxidant electrode current collector 15 are formed into a circular shape slightly smaller than the solid electrolyte 11. Therefore, even if thermal strain occurs in the solid electrolyte 11 at power generation, the outer peripheral portion of the solid electrolyte 11 is not constrained by the constituent members of the fuel cell stack 10 such as the current collectors 14 and 15 and the ring member 17. In addition, the constituent members of the fuel cell stack 10 prevent mechanical stress from acting on the solid electrolyte 11 and thus can prevent cracks from occurring in the solid electrolyte 11.

Furthermore, the plate thickness of the ring member 17 is uniformly formed over the entire periphery so as at least not to be in contact with the solid electrolyte 11, but is thinner than that of the fuel electrode current collector 14 and thus the flatness is poor, but because of its insulating property, even a partial contact with the solid electrolyte 11 may not cause electrical short.

Note that the present invention is not limited to the above embodiments, but for example, the solid electrolyte 11 may be made of other ceramic plate such as YSZ instead of the lanthanum gallate ceramic plate.

Instead of the ring member 17, a raised portion with a height not to be in contact with the solid electrolyte 11 may be formed on the fuel electrode current collector 14 side of the separator 2. In this case, when the fuel cell stack 10 is arranged such that the fuel electrode layer 12 is formed on an upper surface of the solid electrolyte 11, the raised portion does not contact the solid electrolyte 11 like the ring member 17. Thus, the fuel cell stack 10 has a wider range of options in arrangement orientation. Note that the raised portion may be formed by forming a groove in a center portion of the separator 2 or by providing an annular projecting member on an outer peripheral portion of the separator 2. Thus, it would be sufficient for the raised portion to be provided on an outer peripheral portion of the fuel electrode current collector 14. Note that it is preferable that like the ring member 17, even the raised portion is formed to have a uniform height over the peripheral direction.

### INDUSTRIAL APPLICABILITY

As described above, the present invention can provide a fuel cell stack which can prevent both cell voltages from decreasing and cracks from occurring in the solid electrolyte under the action of mechanical stress and a flat plate solid oxide fuel cell using the same.

1. A fuel cell stack having a sealless structure in which a plurality of power generation cells, each of which has a fuel electrode layer formed on one surface of a flat plate-like solid electrolyte and an oxidant electrode layer formed on the other surface thereof, are laminated in a plate thickness direction by interposing a separator which includes a fuel gas path supplying a fuel gas to the fuel electrode layer and an oxidant gas path supplying an oxidant gas to the oxidant electrode layer; in which a fuel electrode current collector is interposed between the fuel electrode layer and the separator and an oxidant electrode current collector is interposed between the oxidant electrode layer and the separator; and in which a reacted gas generated by a reaction between the fuel gas and the oxidant gas and an unreacted gas not used for the reaction are released as an exhaust gas from an outer periphery to outside,
wherein a raised portion with a height not to be in contact with the solid electrolyte formed on the fuel electrode current collector side of the separator is provided on the outer periphery of the fuel electrode current collector.

2. A fuel cell stack having a sealless structure in which a plurality of power generation cells, each of which has a fuel electrode layer formed on a lower surface of a flat plate-like solid electrolyte and an oxidant electrode layer formed on an upper surface thereof, are laminated in a plate thickness direction by interposing a separator which includes a fuel gas path supplying a fuel gas to the fuel electrode layer and an oxidant gas path supplying an oxidant gas to the oxidant electrode layer; in which a fuel electrode current collector is interposed between the fuel electrode layer and the separator and an oxidant electrode current collector is interposed between the oxidant electrode layer and the separator; and in which a reacted gas generated by a reaction between the fuel gas and the oxidant gas and an unreacted gas not used for the reaction are released as an exhaust gas from an outer periphery to outside,
wherein an annular member with a thickness thinner than that of the fuel electrode current collector interposed between the separator and the solid electrolyte is provided on the outer periphery of the fuel electrode current collector.

3. The fuel cell stack according to claim 2, wherein the annular member is a flat plate annular member with a uniform plate thickness over the entire periphery.

4. A flat plate solid oxide fuel cell having a plurality of the fuel cell stacks according to claim 3, wherein
the solid electrolyte is formed into a circular plate shape; the fuel electrode layer is formed into a circular shape; and the fuel electrode current collector is formed into a circular plate shape, and
the flat plate annular member is an annular shaped ring member having an insulating property.
